(19) United States
(12) Patent Application Publication
(10) Pub. No.: US 2026/0196926 A1
(43) Pub. Date: Jul. 9, 2026

(54) MIXED SNUBBER CAPACITANCE FOR PARALLELED SEMICONDUCTORS TO REDUCE ELECTRO-MAGNETIC INTERFERENCE

(71) Applicant: Deere & Company, Moline, IL (US)

(72) Inventors: Dustin OELMANN, Fargo, ND (US); Michael P. LANGSETH, Fargo, ND (US); Richard E. WAINWRIGHT, West Fargo, ND (US); Micah BUSH, Fargo, ND (US)

(73) Assignee: Deere & Company, Moline, IL (US)

(21) Appl. No.: 19/013,677

(22) Filed: Jan. 8, 2025

(51) Int. Cl. H02M 1/34; B60L 15/00; H02M 1/44; H02M 3/335

(52) U.S. Cl. CPC H02M 1/348; B60L 15/007; H02M 1/44; H02M 3/33584; B60L 2210/10

(57) ABSTRACT

A low voltage power stage of a DC-DC converter includes a plurality of switching transistors coupled in parallel with each other associated with a DC voltage. The low voltage power stage also includes a plurality of snubber capacitors having mixed capacitance values coupled in parallel to different switching transistors.

### FIELD

Example embodiments are related to three-phase direct current (DC)-to-DC (DC-DC) converters, and more specifically to DC-DC converters employing snubber capacitors.

### BACKGROUND

DC-DC converters convert an input DC voltage to an output DC voltage. Snubber capacitors may be used to limit voltage transients that tend to occur when switching transistor states during operation of the DC-DC converter. Conventionally, snubber capacitors associated with each of the transistors have the same value, to optimize for switching.

### SUMMARY

Various example embodiments discussed herein employ snubber capacitors having different capacitance values, so that snubber capacitors associated with different transistors ring at different frequencies and thereby spread switching transients over multiple different frequencies. Electromagnetic interference (EMI) tends to increase when additional transistors are used to accommodate high current levels. In some DC-DC converters, using a single snubber capacitance value for each transistor in a low voltage (high current) power stage may result in switching noise generated by each of the switching transistors to be centered around the same frequency. In some cases, the magnitude of the noise at that same frequency may be sufficient to produce enough EMI to cause a DC-DC converter to fail electromagnetic compliance (EMC) testing.

In an example embodiment, a low voltage power stage of a DC-DC converter comprises a plurality of switching transistors coupled in parallel with each other, and a plurality of snubber capacitors coupled in parallel to different switching transistors of the plurality of switching transistors, the plurality of snubber capacitors having mixed capacitance values.

In another example embodiment, a Dual Active Bridge DC-DC converter includes: a high voltage power stage; a low voltage power stage; a transformer coupling the high voltage power stage to the low voltage power stage, the high voltage power stage including first circuitry configured to during operation in a down-conversion mode, generate a high voltage, time varying output signal based on a high voltage DC input signal, transmit the high voltage, time varying output signal to the transformer; and during operation in an up-conversion mode receive a high voltage, time varying input signal from the transformer, and generate a high voltage DC output signal based on the high voltage, time varying input signal; the low voltage power stage including second circuitry configured to during operation in the up-conversion mode, generate a low voltage, time varying output signal based on a low voltage DC input signal, and transmit the low voltage, time varying output signal to the transformer, and during operation in the down-conversion mode receive a low voltage, time varying input signal from the transformer, and generate a low voltage DC output signal based on the low voltage, time varying input signal; and the second circuitry including a plurality of switching transistors coupled in parallel with each other, and a plurality of snubber capacitors coupled in parallel to different switching transistors of the plurality of switching transistors, the plurality of snubber capacitors having mixed capacitance values.

In yet another example embodiment, a method of converting a first DC voltage to a second DC voltage includes converting the first DC voltage to a first time varying voltage using first switching transistors; transforming the first time varying voltage to a second time varying voltage, different from the first time varying voltage, using a transformer; converting the second time varying voltage to the second DC voltage using second switching transistors, the second DC voltage being different from the first DC voltage; and at least one of converting the first DC voltage to the first time varying voltage, or converting the second time varying voltage to the second DC voltage, include spreading noise signals generated by corresponding switching transistors over a plurality of different frequencies.

The following non-limiting illustrative embodiments are also provided to aid in understanding the present disclosure. Illustrative embodiment 1 includes a low voltage power stage of a DC-DC converter (240), the low voltage power stage comprising: a plurality of switching transistors coupled in parallel with each other (320, 322, 324, 326, 328, 330, 332, 334, 336); and a plurality of snubber capacitors (310, 311, 312, 313, 314, 315, 316, 317, 318, 319) coupled in parallel to different switching transistors of the plurality of switching transistors, the plurality of snubber capacitors having mixed capacitance values.

Illustrative embodiment 2 includes the low voltage power stage of the DC-DC converter as in illustrative embodiment 1, wherein the plurality of snubber capacitors are configured to spread noise signals generated by the switching transistors over a plurality of different frequencies.

Illustrative embodiment 3 includes the low voltage power stage of the DC-DC converter as in either illustrative embodiments 1 or 2, wherein: the plurality of snubber capacitors are individually constrained to have a minimum capacitance value in accordance with an overvoltage threshold; and the plurality of snubber capacitors are individually constrained to have a maximum capacitance value in accordance with a dissipation threshold.

Illustrative embodiment 4 includes the low voltage power stage of the DC-DC converter as in illustrative embodiment 3, wherein the plurality of snubber capacitors have capacitance values distributed over a range of capacitance values bounded by the minimum capacitance value and the maximum capacitance value.

Illustrative embodiment 5 includes the low voltage power stage of the DC-DC converter as in illustrative embodiment 4, wherein: the plurality of snubber capacitors have capacitance values separated by a minimum of about 10% of the range of capacitance values.

Illustrative embodiment 6 includes the low voltage power stage of the DC-DC converter as in any of illustrative embodiments 1-5, wherein the low voltage power stage further includes: a plurality of voltage sections (261, 262, 263); and each of the plurality of voltage sections includes separate groups of switching transistors with corresponding snubber capacitors having mixed capacitance values.

Illustrative embodiment 7 includes a Dual Active Bridge DC-DC converter (114), wherein the Dual Active Bridge DC-DC converter further comprises: a high voltage power stage (220); a low voltage power stage as in any of claims 1-6; a transformer (230) coupling the high voltage power stage to the low voltage power stage, the high voltage power stage including first circuitry (460, 461, 462, 463, 464, 464) configured to during operation in a down-conversion mode, generate a high voltage, time varying output signal based on a high voltage DC input signal, transmit the high voltage, time varying output signal to the transformer; and during operation in an up-conversion mode, receive a high voltage, time varying input signal from the transformer, and generate a high voltage DC output signal based on the high voltage, time varying input signal; the low voltage power stage including second circuitry (320, 322, 324, 326, 328, 330, 332, 334, 336, 310, 311, 312, 313, 314, 315, 316, 317, 318, 319) configured to during operation in the up-conversion mode, generate a low voltage, time varying output signal based on a low voltage DC input signal, and transmit the low voltage, time varying output signal to the transformer, and during operation in the down-conversion mode, receive a low voltage, time varying input signal from the transformer, and generate a low voltage DC output signal based on the low voltage, time varying input signal; and the second circuitry including, a plurality of switching transistors coupled in parallel with each other, and a plurality of snubber capacitors coupled in parallel to different switching transistors of the plurality of switching transistors (320, 322, 324, 326, 328, 330, 332, 334, 336, 310, 311, 312, 313, 314, 315, 316, 317, 318, 319), the plurality of snubber capacitors having mixed capacitance values.

Illustrative embodiment 8 includes the Dual Active Bridge DC-DC converter as in illustrative embodiment 7, wherein: the high voltage power stage includes a high voltage DC connection coupled to an electrical system of a vehicle (224, 225); and the low voltage power stage includes a low voltage DC connection configured to be electrically coupled to a low voltage DC implement (244, 245).

Illustrative embodiment 9 includes a method of converting a first DC voltage to a second DC voltage, the method comprising: converting the first DC voltage to a first time varying voltage (520) using first switching transistors; transforming the first time varying voltage to a second time varying voltage (530), different from the first time varying voltage, using a transformer; converting the second time varying voltage to the second DC voltage (540) using second switching transistors, the second DC voltage being different from the first DC voltage; and at least one of converting the first DC voltage to the first time varying voltage, or converting the second time varying voltage to the second DC voltage, include spreading noise signals (830) generated by corresponding switching transistors over a plurality of different frequencies.

Illustrative embodiment 10 includes the method as in illustrative embodiment 9, wherein spreading the noise signals includes: using a plurality of snubber capacitors having mixed capacitance values (830).

Illustrative embodiment 11 includes the method as in illustrative embodiment 10, wherein using the plurality of snubber capacitors having mixed capacitance values includes: using snubber capacitors having capacitance values dispersed over a range of capacitance values bounded by a minimum capacitance value set in accordance with an overvoltage threshold and a maximum capacitance value set in accordance with a dissipation threshold.

Illustrative embodiment 12 includes the method as in illustrative embodiment 11, wherein using the snubber capacitors having capacitance values dispersed over the range of capacitance values includes: using snubber capacitors having capacitance values separated by a minimum of about 10% of the range of capacitance values.

Illustrative embodiment 13 includes the method as in any of illustrative embodiments 9-12, further comprising: generating a plurality of different DC voltages using separate groups of switching transistors associated with corresponding snubber capacitors having different capacitance values.

Illustrative embodiment 14 includes the method as in any of illustrative embodiments 9-13, further comprising: down-converting a DC voltage provided by a vehicle electrical system to generate a down-converted DC voltage compatible with a driven implement electrical system (550).

Illustrative embodiment 15 includes the method as in any of illustrative embodiments 9-14, further comprising: up-converting a DC voltage provided by a driven implement electrical system to generate a down-converted voltage compatible with a vehicle electrical system (650).

### BRIEF DESCRIPTION OF THE DRAWINGS

Example embodiments will be more clearly understood from the following detailed description taken in conjunction with the accompanying drawings. FIGS. 1-9 represent non-limiting, example embodiments as described herein.

FIG. 1 is a block diagram illustrating a system including a DC-DC converter according to one or more example embodiments;

FIG. 2 is a block diagram of a DC-DC converter according to one or more example embodiments;

FIGS. 3A-3B are schematic diagrams illustrating circuitry of a single phase of a multiple phase low voltage power stage of a DC-DC converter including mixed-value snubber capacitors according to one or more example embodiments;

FIGS. 4A-4B are schematic diagrams illustrating a high-voltage power stage of a DC-DC converter according to one or more example embodiments;

FIG. 5 is a flowchart illustrating a method of using a DC-DC converter to step down high voltages to low voltages according to one or more example embodiments;

FIG. 6 is a flowchart illustrating a method of using a DC-DC converter to step up low voltages to high voltages according to one or more example embodiments;

FIG. 7 is a flowchart illustrating a method of spreading noise signals in a low voltage power stage of a DC-DC converter during operation in a down-conversion mode according to one or more example embodiments;

FIG. 8 is a flowchart illustrating a method of spreading noise signals in a low voltage power stage of a DC-DC converter during operation in an up-conversion mode according to one or more example embodiments; and

FIG. 9 is a graph illustrating radiated emissions of a DC-DC converter with and without mixed-value snubber capacitors according to one or more example embodiments.

### DETAILED DESCRIPTION

Example embodiments disclosed herein are capable of being implemented with various modifications and alternative forms, and some such example embodiments are illustrated in the drawings and described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Example embodiments of using mixed snubber capacitance with paralleled semiconductors to reduce electro-magnetic interference will now be described more fully with reference to the accompanying drawings in which some example embodiments are illustrated. Particular embodiments discussed herein refer to DC-DC converters including a low voltage power stage including multiple parallel transistors, with each transistor or transistor pair having a snubber capacitor with a different capacitance value. In some example embodiments, one or more transistors and or transistor pairs may use capacitors having the same, or substantially the same, capacitance values, as long as at least one transistor or transistor pair is associated with different capacitance values. In some such example embodiments, switching noise associated with the parallel capacitors may be distributed over a smaller number of frequencies, but the switching noise is still distributed across more than one frequency, thereby reducing a magnitude of electromagnetic interference produced at one or more frequencies.

As used herein, the terms “high voltage” and “low voltage” are to be understood as being high or low relative to each other, so that the high voltage system or the high voltage power stage of the DC-DC converter operates on a greater absolute voltage value than the low voltage system or the low voltage power stage of the DC-DC converter..

Those of ordinary skill in the art will understand that the high voltage side of the DC-DC converter will generally have a lower current than the low voltage side of the DC-DC converter, due to the transformers used to up-convert/down-convert the voltage level between the high voltage and low voltage power stages of the DC-DC converter. In some example embodiments, the lower current in the high voltage power stage of the DC-DC converter may not require the use of multiple parallel transistors during pulse-width modulation of the DC voltage in down/up-conversion operation of the DC-DC converter, whereas the higher currents present in the low voltage power stage may require multiple parallel transistors. In at least one example embodiment, switching noise in the high voltage/low current power stage of the DC-DC converter is less problematic than switching noise in the low voltage/high current power stage because of the parallel connected transistors in the low voltage power stage.

Thus, in at least one example embodiment, snubber capacitors having mixed-capacitance values may be used on the low voltage side of the DC-DC converter, but not on the high voltage side. However, other embodiments are not so limited, and may include mixed-value snubber capacitors may be used in either or both stages of the DC-DC converter.

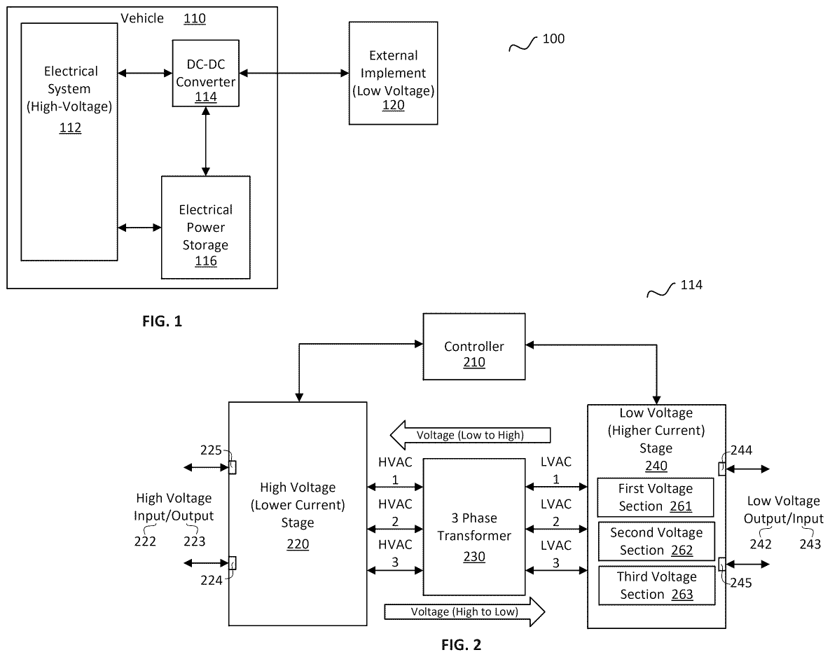

Referring first to FIG. 1 a system 100 including a DC-DC converter 114 will be discussed in accordance with one or more example embodiments. The system 100 includes a vehicle 110 electrically coupled to a low voltage external implement 120. The vehicle 110 includes a high voltage electrical system 112, electrical power storage 116, and DC-DC converter 114. In some example embodiments, the high voltage electrical system 112 of the vehicle is in the range of about 650-800 VDC, and the low voltage external implement operates using a voltage in the range of between about 48 VDC to 60 VDC. In at least one example embodiment, the external implement has an operating voltage of about 56 VDC.

Other example embodiments may use different voltages, and in some example embodiments the vehicle 110 may employ a low voltage system while the external implement uses a high voltage system. In many current systems, however, such as heavy construction equipment and farm equipment, the vehicle employs a high voltage electrical system, while an attached implement uses a low voltage electrical system. In some such example embodiments, the vehicle 110 may include more than one electrical system, with one on-board electrical system being a high voltage electrical system, and another on board electrical system being a low voltage electrical system. Furthermore, although not explicitly illustrated, the vehicle 110 may be a hybrid vehicle including a combustion engine and one or more motor generators.

In the illustrated example embodiment, the DC-DC converter 114 may be a dual active bridge (DAB) DC-DC converter capable of being coupled to both, the high voltage electrical system 112 of the vehicle and the low voltage external implement 120 to allow for power transfer from the vehicle 110 to the low voltage external implement 120, and/or vice versa. Consider, for example, the case where the low voltage external implement is an electrically driven implement, such as a hay rake operating in the range of between about 48 VDC to 60 VDC, and the vehicle is a hybrid or fully electric farm tractor operating on 680 VDC. The DC-DC converter may be used in a down-convert mode to convert 680 VDC, used by the vehicle, to in the range of between about 48 VDC to 60 VDC for use by the electrically driven implement. Conversely, the DC-DC converter may be used in an up-convert mode to convert power generated by the electrically driven implement, which may be in the range of between about 48 VDC to 60 VDC, to 680 VDC for use in charging the vehicle's batteries, supplementing motive force being provided by motor generators and/or a combustion engine on board the vehicle, or the like.

It should be noted that although various example embodiments discuss the use of the disclosed DC-DC converter in the context of vehicles and attached implements, use of the disclosed DC-DC converter is not limited to use in a vehicular context, but instead may be used in any situation in which a high DC voltage is converted to a low DC voltage, or vice versa, and/or applications where DC-DC converter switching noise is a design consideration.

The disclosed example embodiments of DC-DC converters, vehicles including such DC-DC converters, external implements suitable for use with and potentially including the disclosed DC-DC converters, and methods of using the disclosed DC-DC converter differ from conventional devices and techniques, as discussed further with reference to FIGS. 2-9. At least one difference between conventional DC-DC converter and the disclosed example embodiments is the use of snubber capacitors and/or snubber capacitor circuits to spread switching noise associated with parallel coupled capacitors by using snubber capacitors having mixed capacitance values. Other differences will become apparent upon further consideration of the claims and the disclosure.

The basic principles of operation of DC-DC converters are well understood by those of ordinary skill in the art. Some specifics regarding operation of a DC-DC converter that does not employ mixed value snubber capacitors in its low voltage power stage, and a controller thereof, may be found in US Patent Publication Number US 2024/0162804 A1, filed on Nov. 1, 2023 and entitled, “Reduced Energy Loss Control Methods for DC-DC Converters,” the entire contents of which is hereby incorporated herein by reference.

Referring next to FIG. 2, a DC-DC converter 114 will be discussed in accordance with one or more example embodiments. The DC-DC converter 114 includes a high voltage power stage 220 coupled to a low voltage power stage 240 via a three phase transformer 230, and a controller 210 configured to control switching operations of the high voltage power stage 220 and the low voltage power stage 240. Low power stage 240 includes three voltage sections 261, 262, and 263, each of which is associated with one phase of the transformer 230, and which may be configured by controller 210 to output the same or different voltages. Because each voltage section includes the same circuit configuration, the following discussion focuses on only a voltage section.

In one or more example embodiments, DC-DC converter 114 may be operated in either a down-conversion mode and/or an up-conversion mode. During a down-conversion mode a high voltage DC input signal 222 is applied across high voltage DC terminals 224 and 225 of the high voltage power stage 220, which generates three high voltage, time varying output signals, such as time varying high voltage signals HVAC1, HVAC2, and HVAC3, based on the high voltage DC input signal 222. The time varying signals HVAC1, HVAC2, and HVAC3 may be transmitted to the 3 phase transformer 230. In at least one example embodiment, the time varying signals HVAC1, HVAC2, and HVAC3 include pulse width modulated signals. The duty cycle of the pulse width modulated signals may be controlled by controller 210 based on a difference between the input and output voltages of the DC-DC converter.

The three phase transformer 230 steps down the high voltage, time varying signals, e.g. HVAC1, HVAC2, and HVAC3, to generate three low voltage, time varying signals, e.g. LVAC1, LVAC2 and LVAC3. The low voltage, time varying signals are provided to different voltage sections of the low voltage power stage 240, which convert the low voltage, time varying signals into a low voltage DC output signal 242 output across low voltage DC terminals 244 and 245 under control of controller 210.

During an up-conversion mode, a low voltage DC input signal 243 is applied across low voltage DC terminals 244 and 245 of the low voltage power stage 240, which generates three low voltage, time varying output signals, such as time varying low voltage signals LVAC1, LVAC2, and LVAC3, based on the low voltage DC input signal 243. The time varying low voltage signals LVAC1, LVAC2, and LVAC3 may be transmitted to the 3 phase transformer 230. In at least one example embodiment, the time varying low voltage signals LVAC1, LVAC2, and LVAC3 include pulse width modulated signals. The duty cycle of the pulse width modulated signals may be controlled by controller 210 based on a difference between the input and output voltages of the DC-DC converter.

The three phase transformer 230 steps up the low voltage, time varying signals, e.g. LVAC1, LVAC2, and LVAC3, to generate three high voltage, time varying signals, e.g. HVAC1, HVAC2 and HVAC3. The high voltage, time varying signals are provided to the high voltage power stage 220, which converts the high voltage, time varying input signals into a high voltage DC output signal 223.

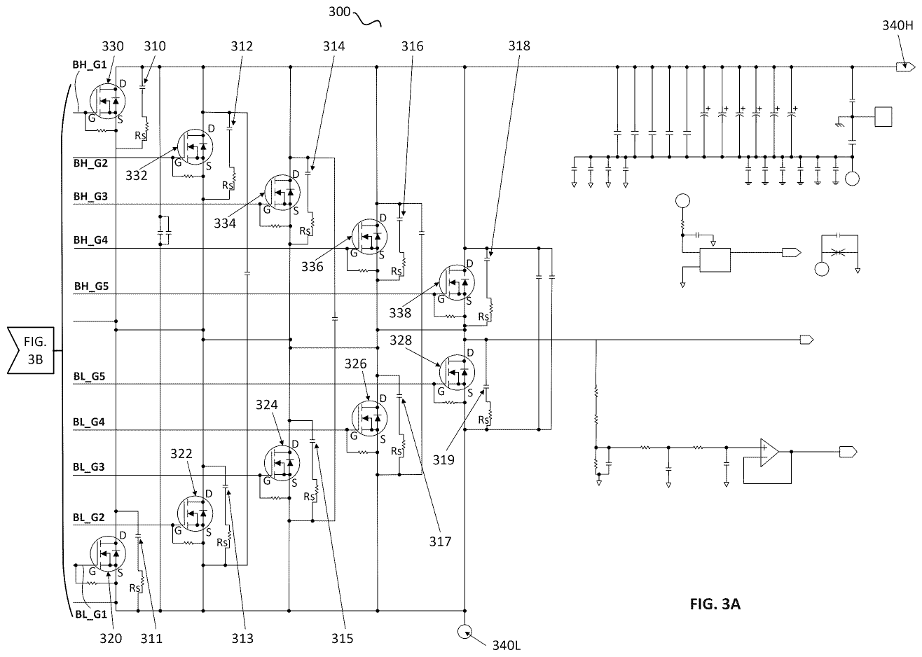

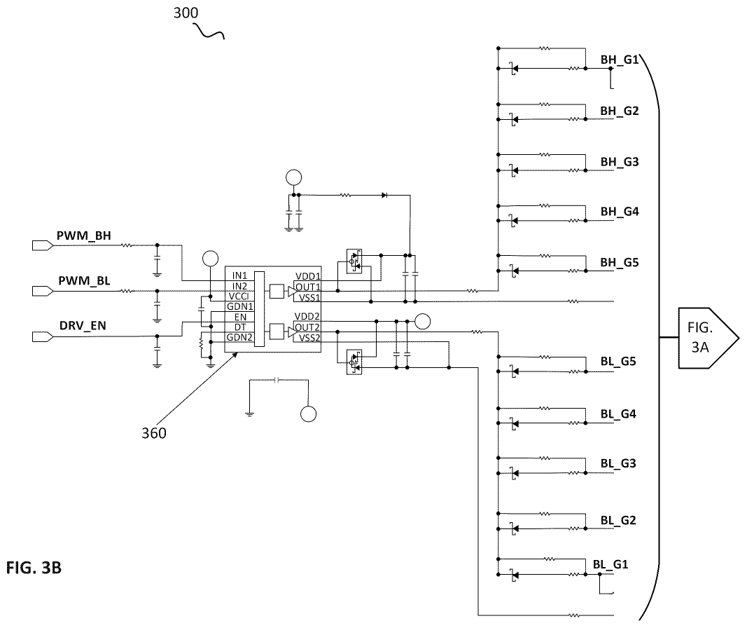

Referring next to FIGS. 3A-3B, circuitry of a single phase 300 of a multiple phase low voltage power stage of a DC-DC converter including mixed-value snubber capacitors will be discussed in accordance with one or more example embodiments. In at least one example embodiment, the circuitry of the single phase 300 is one phase of the low voltage power stage 240 of DC-DC converter 114 (FIG. 2). During a down-conversion mode of operation, a low voltage time varying signal, such as LVAC2 is applied across terminal 340H and low side common 340L. The high side of LVAC2 and applied to the drains of the high side power MOSFET transistors 330, 332, 334, 336, and 338. The low side of LVAC2 is applied to the drains of the low side power MOSFET transistors 320, 322, 324, 326, and 328. In conjunction with the LVAC2 time varying signal being applied to the drains of power MOSFET transistors, gate control signals BH_G1, BH_G2, BH_G3, BH_G4, BH_G5, BL_G1, BL_G2, BL_G3, BL_G4, and BL_G5 are used to switch corresponding transistors on/off to convert the LVAC2 to a DC Voltage. As illustrated in FIG. 3B, the gate control signals BH_G1, BH_G2, BH_G3, BH_G4, BH_G5, BL_G1, BL_G2, BL_G3, BL_G4, and BL_G5 are generated based on outputs from half-bridge gate driver 360, which in turn are based on pulse width modulation signals PWM_BH and PWM_BL, and drive enable signal DRV_EN provided by controller 210 (FIG. 2).

In various example embodiments, each time one of the transistors is switched on/off, undesirable electromagnetic emissions may be generated. The electromagnetic transmission from multiple transistors being switched on/off may be additive, which could cause the total electronic emissions to exceed acceptable levels. To mitigate the likelihood that the electromagnetic emissions at any one frequency will exceed acceptable levels, snubber capacitors 310, 311, 312, 313, 314, 315, 316, 317, and 318 with varying capacitance values are used to spread the electromagnetic emissions over multiple different frequencies. In the illustrated example embodiment, each of the snubber capacitors is placed in series with a resistor Rₛ, with each snubber capacitor and resistor combination placed in parallel across different power MOSFET transistors.

In at least one example embodiment, the snubber capacitors are selected to have capacitances in a range of between about 1.5 nF and 4.7 nF, with 1.5 nF selected to provide acceptable overvoltage protection, and 4.7 nF selected to maintain acceptable power dissipation. In at least one such example embodiment, it is desirable to maximize the frequency spread produced by the snubber capacitors within the available range of capacitances, e.g., between about 1.5 nF and 4.7 nF. To maximize the frequency spread provided by the snubber capacitors, the capacitance values of the snubber capacitors should be spread across the available range of capacitance values, while maintaining a minimum of about 10% separation. In at least one example embodiment, the range of capacitance values is divided by the number of devices in parallel, five power MOSFET transistors in the example embodiment illustrated in FIGS. 3A-3B, and capacitance values for the snubber capacitors may be selected accordingly. Standard commonly available capacitance values are 1.5 nF, 1.8 nF, 2.2 nF, 2.7 nF, 3.3 nF, 3.9 nF, and 4.7 nF. In at least one example embodiment, standard capacitance values of 1.5 nF, 2.2 nF, 3.3 nF, 3.9 nF and 4.7 nF are selected to achieve the desired spread of capacitance values, while leaving about 20% separation.

Operation in an up-conversion mode is similar to operation in the down conversion mode, except that in the up conversion mode a low voltage signal is received as input at terminal 340H, and gate control signals BH_G1, BH_G2, BH_G3, BH_G4, BH_G5, BL_G1, BL_G2, BL_G3, BL_G4, and BL_G5 are used to cause the transistors in low voltage power stage to pulse-width modulate the received DC voltage signal, and convert the DC voltage signal to a three-phase low voltage time varying signal, which is provided to the three phase transformer 230. Three phase transformer 230 up-converts the low voltage time varying signal to generate a high voltage time varying signal that the three phase transformer 230 provides to the high voltage power stage 220. The high voltage power stage 220 outputs a high voltage DC signal via the first terminal 415 and the second terminal 417.

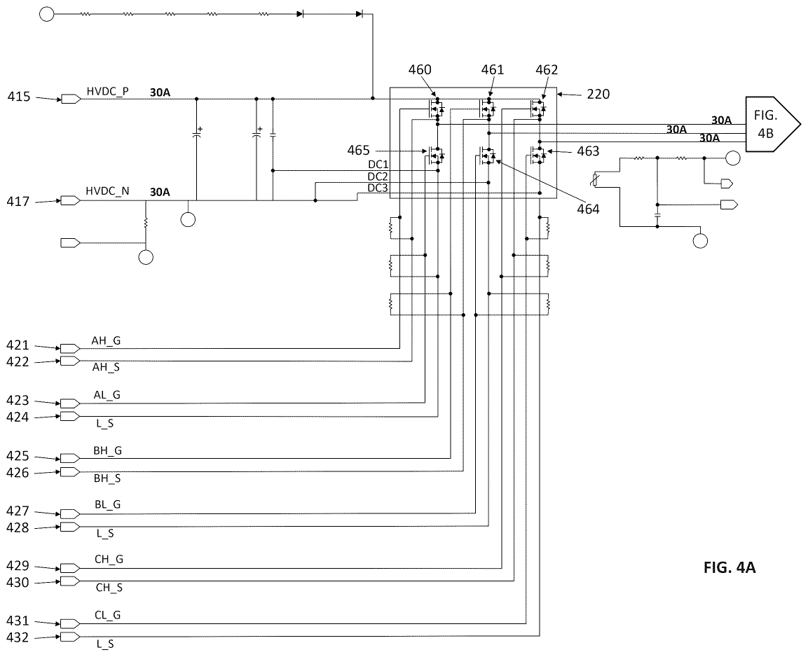

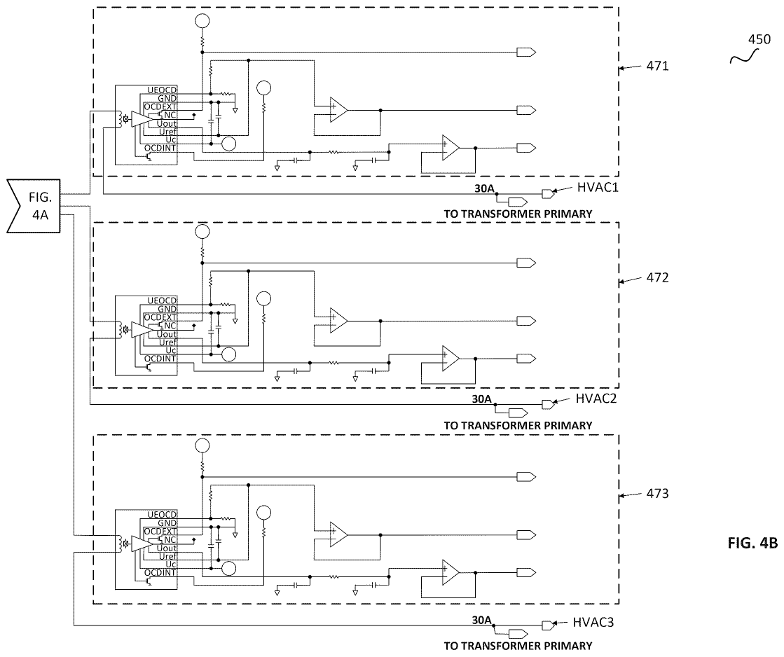

Referring next to FIGS. 4A-4B, a high voltage power stage 220 of a DC-DC converter will be discussed in accordance with one or more example embodiments. In a down-conversion mode of operation, the high voltage power stage 220 receives a high-voltage positive DC signal via first terminal 415, and a high voltage negative DC signal via second terminal 417. Gate control signals 421, 423, 425, 427, 429, and 431 and source signals 422, 424, 426, 428, 430, and 432 are used to control transistors 460, 461, 462, 463, 464, and 465, which are included in high voltage power stage 220, to pulse width modulate the input high voltage input signals to generate three high voltage time varying signals. The high voltage time varying signals are stepped down by three phase transformer 230 (FIG. 1) to generate low voltage time varying signals, which are provided to the low voltage power stage 240. Circuit segments 471, 472, and 473 are voltage sampling circuits, which may provide voltage-control feedback to controller 210. Controller 210 may use the feedback to adjust the gate and source signals 421-432, or to otherwise control the switching operations of the transistors.

Operation in an up-conversion mode is similar to operation in the down conversion mode, except that in the up conversion mode, time varying signals generated by the low voltage power stage 240, and up-converted by three phase transformer 230, are received as input to the high voltage power stage, and the gate control and source signals are used to convert the received time varying signal to a DC signal output via first terminal 415 and second terminal 417.

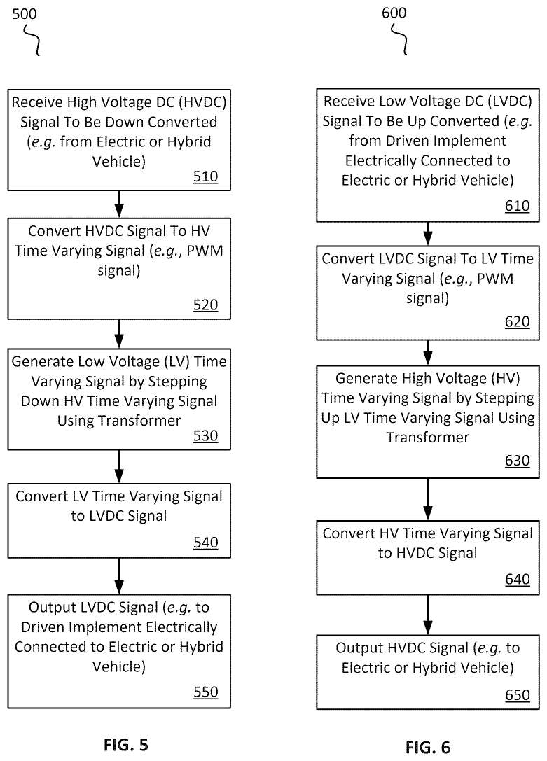

Referring next to FIG. 5, a method 500 of using a DC-DC converter to step down high voltages to low voltages will be discussed in accordance with one or more example embodiments. As illustrated by block 510, a high voltage DC signal to be down-converted is received at a DC-DC converter, such as DC-DC converter 114 (FIG. 1). In at least one example embodiment, the high voltage DC signal to be converted includes, but is not limited to, a voltage between about 650 VDC and 800 VDC. In other example embodiments, the high voltage DC signal may be less than 650 VDC. In at least some example embodiments, the high voltage signal corresponds to a high voltage vehicular electrical system, including, but not limited to, a high voltage electrical system 112 of a hybrid or all-electric vehicle.

As illustrated by block 520, the high voltage DC signal is converted to a high voltage time varying signal, including but not limited to, a pulse width modulated signal, in a high voltage power stage of the DC-DC converter. As illustrated by block 530, the high voltage time varying signal is down-converted to a low voltage time varying signal by a transformer, such as three phase transformer 230.

As illustrated by block 540, a low voltage power stage of the DC-DC converter converts the low voltage time varying signal to a low voltage DC signal. In some example embodiments, the low voltage DC signal may be, but is not limited to, a voltage between 12 and 100 volts. In at least one example embodiment, the low voltage DC signal is between about 48 and about 60 volts, and may be set based on an operating voltage of an implement connected electrically to the vehicle.

As illustrated by block 550, the low voltage DC signal is delivered to an implement connected electrically to a vehicle on which the DC-DC converted is included. In at least one example embodiment, the implement includes, but is not limited to, an electrically driven implement operating using a lower voltage than used by the electrical system of the vehicle to which it is electrically connected.

Referring next to FIG. 6, a method 600 of using a DC-DC converter to step up low voltages to high voltages will be discussed in accordance with one or more example embodiments.

As illustrated by block 610, a low voltage DC signal to be up-converted is received at a low voltage power stage of a DC-DC converter, for example the low voltage power stage 240 of DC-DC converter 114. In some example embodiments, the low voltage DC signal may be received from an implement electrically connected to a vehicle having a high voltage power system. This may allow, in one example embodiment, an electrically driven implement to act in a power generation mode, in which a motor generator used to provide motive force to the implement generates electricity when, for example, being towed.

As illustrated by block 620, the low voltage DC signal is converted by the low voltage power stage of the DC-DC converter to a low voltage time varying signal, for example by pulse width modulating the low voltage DC signal. As illustrated by block 630, the low voltage time varying signal is up-converted to a high voltage time varying signal by a transformer, for example the three phase transformer 230.

As illustrated by block 640, the high voltage time varying signal is converted to a high voltage DC signal by the high voltage power stage 220. As illustrated by block 650, the high voltage DC signal may be provided to the high voltage electrical system 112 (FIG. 1). In some example embodiments, the high voltage DC signal may be used to charge a battery included in electrical power storage 116.

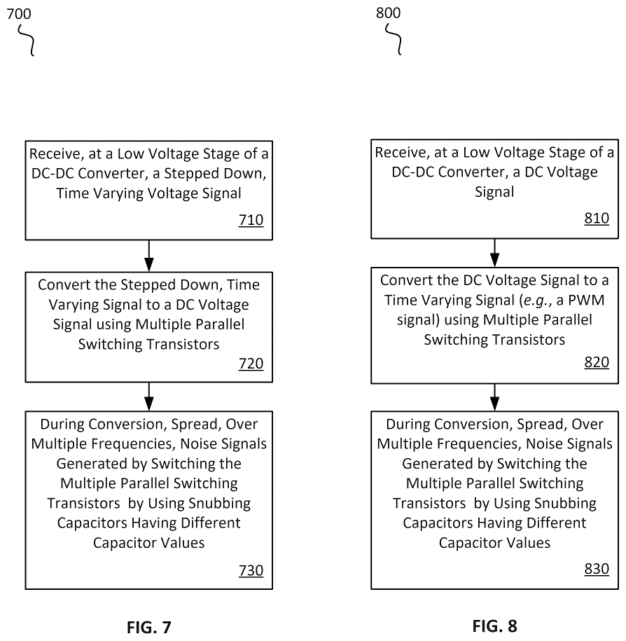

Referring next to FIG. 7, a method 700 of spreading noise signals in a low voltage power stage of a DC-DC converter during operation in a down-conversion mode will be discussed in accordance with one or more example embodiments. As illustrated by block 710, a stepped down, time varying voltage is received at a low voltage power stage, e.g., the low voltage power stage 240 of a DC-DC converter 114. As illustrated by block 720, the low voltage power stage converts the time varying signal to a low voltage DC signal using multiple switching transistors coupled in parallel, as discussed with reference to FIGS. 3A-3B. As illustrated by block 730, during conversion of the low voltage time varying signal to a DC signal spreading the switching noise generated by switching the transistors over multiple frequencies using a plurality of snubber capacitors having a range of different capacitance values.

Referring next to FIG. 8, a method 800 of spreading noise signals in a low voltage power stage of a DC-DC converter during operation in an up-conversion mode will be discussed in accordance with one or more example embodiments. As illustrated by block 810, a low voltage DC signal is received at a low voltage power stage, e.g., the low voltage power stage 240 of a DC-DC converter 114. As illustrated by block 820, the low voltage DC signal is converted to a low voltage time varying signal using multiple parallel switching transistors, as discussed with respect to FIGS. 3A-3B. As illustrated by block 830, during conversion of the low voltage DC signal to the low voltage time varying signal, spreading the switching noise generated by switching the transistors over multiple frequencies using a plurality of snubber capacitors having a range of different capacitance values.

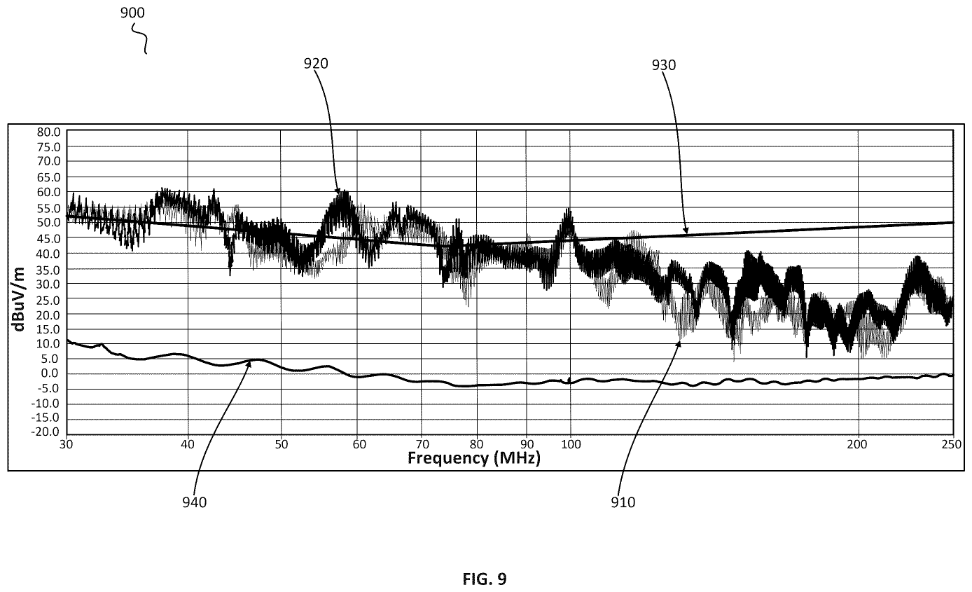

Referring next to FIG. 9, a graph 900 illustrating radiated emissions of a DC-DC converter with and without mixed-value snubber capacitors will be discussed in accordance with one or more example embodiments. Plot 910 illustrates radiated emissions of a DC-DC converter including a low voltage converter as illustrated in FIGS. 3A-3B employing snubber capacitors having mixed values. Plot 920 illustrates radiated emissions of a similar DC-DC converter, but employing conventional snubber capacitors without mixed values. Plots 910 and 920 use an average power measurement at each measured frequency; the frequency is measured over some time and the average received power is used as the reported measurement. Other forms of measurement that may be used include quasi peak and peak power. Plot 930 shows the compliance limit for radiated emissions, while plot 940 shows the ambient noise due to test equipment with the DC-DC converter unpowered, and subsequently in an off state.

The radiated emissions were measured by an antenna in a vertical orientation 1 meter from the DC-DC converter. The y axis of graph 900 is the signal strength in dBuV/m, and the x axis of graph is the frequency measured in MHz and displayed in logarithmic scale.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware.

Such existing hardware (e.g., data processors and controllers) may be implemented using processing or control circuitry such as, but not limited to, one or more processors, one or more Central Processing Units (CPUs), one or more microcontrollers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits.

Further, at least one embodiment of the invention relates to a non-transitory computer-readable storage medium comprising electronically readable control information stored thereon, configured such that when the storage medium is used in a controller of a DC-DC converter, at least one embodiment of the method is carried out.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Furthermore, various information regarding stored images, for example, property information, may be stored in any other form, or it may be provided in other ways. The term code, as may be used above, may include software, firmware, and/or microcode, and may refer to programs, routines, functions, classes, data structures, and/or objects.

The term memory is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways. The term data storage device may be used interchangeably with computer-readable medium.

What is claimed is:

1. A low voltage power stage of a DC-DC converter, the low voltage power stage comprising:
a plurality of switching transistors coupled in parallel with each other; and
a plurality of snubber capacitors coupled in parallel to different switching transistors of the plurality of switching transistors, the plurality of snubber capacitors having mixed capacitance values.

2. The low voltage power stage of the DC-DC converter as in claim 1, wherein:
the plurality of snubber capacitors are configured to spread noise signals generated by the switching transistors over a plurality of different frequencies.

3. The low voltage power stage of the DC-DC converter as in claim 1, wherein:
the plurality of snubber capacitors are individually constrained to have a minimum capacitance value in accordance with an overvoltage threshold; and
the plurality of snubber capacitors are individually constrained to have a maximum capacitance value in accordance with a dissipation threshold.

4. The low voltage power stage of the DC-DC converter as in claim 3, wherein
the plurality of snubber capacitors have capacitance values distributed over a range of capacitance values bounded by the minimum capacitance value and the maximum capacitance value.

5. The low voltage power stage of the DC-DC converter as in claim 4, wherein:
the plurality of snubber capacitors have capacitance values separated by a minimum of about 10% of the range of capacitance values.

6. The low voltage power stage of the DC-DC converter as in claim 1, wherein the low voltage power stage further includes:
a plurality of voltage sections; and
each of the plurality of voltage sections includes separate groups of switching transistors with corresponding snubber capacitors having mixed capacitance values.

7. A Dual Active Bridge DC-DC converter comprising:
a high voltage power stage;
a low voltage power stage;
a transformer coupling the high voltage power stage to the low voltage power stage,
the high voltage power stage including first circuitry configured to
during operation in a down-conversion mode,
generate a high voltage, time varying output signal based on a high voltage DC input signal,
transmit the high voltage, time varying output signal to the transformer; and
during operation in an up-conversion mode,
receive a high voltage, time varying input signal from the transformer, and
generate a high voltage DC output signal based on the high voltage, time varying input signal;
the low voltage power stage including second circuitry configured to
during operation in the up-conversion mode,
generate a low voltage, time varying output signal based on a low voltage DC input signal, and
transmit the low voltage, time varying output signal to the transformer, and
during operation in the down-conversion mode,
receive a low voltage, time varying input signal from the transformer, and
generate a low voltage DC output signal based on the low voltage, time varying input signal; and
the second circuitry including,
a plurality of switching transistors coupled in parallel with each other, and
a plurality of snubber capacitors coupled in parallel to different switching transistors of the plurality of switching transistors, the plurality of snubber capacitors having mixed capacitance values.

8. The Dual Active Bridge DC-DC converter as in claim 7, wherein:
the plurality of snubber capacitors are configured to spread noise signals generated by the plurality of switching transistors over a plurality of different frequencies.

9. The Dual Active Bridge DC-DC converter as in claim 7, wherein:
the plurality of snubber capacitors are individually constrained to have a minimum capacitance value in accordance with an overvoltage threshold; and
the plurality of snubber capacitors are individually constrained to have a maximum capacitance value in accordance with a dissipation threshold.

10. The Dual Active Bridge DC-DC converter as in claim 9, wherein
the plurality of snubber capacitors have capacitance values distributed over a range of capacitance values bounded by the minimum capacitance value and the maximum capacitance value.

11. The Dual Active Bridge DC-DC converter as in claim 10, wherein:
the plurality of snubber capacitors have capacitance values separated by a minimum of about 10% of the range of capacitance values.

12. The Dual Active Bridge DC-DC converter as in claim 7, wherein the high voltage power stage further includes:
a plurality of voltage sections; and
each of the plurality of voltage sections includes separate groups of switching transistors with corresponding snubber capacitors having mixed capacitance values.

13. The Dual Active Bridge DC-DC converter as in claim 7, wherein:
the high voltage power stage includes a high voltage DC connection coupled to an electrical system of a vehicle; and
the low voltage power stage includes a low voltage DC connection configured to be electrically coupled to a low voltage DC implement.

14. A method of converting a first DC voltage to a second DC voltage, the method comprising:
converting the first DC voltage to a first time varying voltage using first switching transistors;
transforming the first time varying voltage to a second time varying voltage, different from
the first time varying voltage, using a transformer;
converting the second time varying voltage to the second DC voltage using second switching transistors, the second DC voltage being different from the first DC voltage; and
at least one of converting the first DC voltage to the first time varying voltage, or converting the second time varying voltage to the second DC voltage, include spreading noise signals generated by corresponding switching transistors over a plurality of different frequencies.

15. The method as in claim 14, wherein spreading the noise signals includes:
using a plurality of snubber capacitors having mixed capacitance values.

16. The method as in claim 15, wherein using the plurality of snubber capacitors having mixed capacitance values includes:
using snubber capacitors having capacitance values dispersed over a range of capacitance values bounded by a minimum capacitance value set in accordance with an overvoltage threshold and a maximum capacitance value set in accordance with a dissipation threshold.

17. The method as in claim 16, wherein using the snubber capacitors having capacitance values dispersed over the range of capacitance values includes:
using snubber capacitors having capacitance values separated by a minimum of about 10% of the range of capacitance values.

18. The method as in claim 15 further comprising:
generating a plurality of different DC voltages using separate groups of switching transistors associated with corresponding snubber capacitors having different capacitance values.

19. The method as in claim 14, further comprising:
down-converting a DC voltage provided by a vehicle electrical system to generate a down-converted DC voltage compatible with a driven implement electrical system.

20. The method as in claim 14, further comprising:
up-converting a DC voltage provided by driven implement electrical system to generate a down-converted voltage compatible with a vehicle electrical system.
